(19) United States
(12) Patent Application Publication
(10) Pub. No.: US 2026/0226786 A1
(43) Pub. Date: Aug. 6, 2026

(54) MODULAR WALL START, MODULAR WALL TELESCOPING START, AND COMPOSITE DOOR

(71) Applicant: DIRTT Environmental Solutions Ltd., Calgary (CA)

(72) Inventors: Adam J. Stosky, Calgary (CA); Sandra D. Staerk, Red Deer (CA)

(21) Appl. No.: 19/043,344

(22) Filed: Jan. 31, 2025

Related U.S. Application Data
(60) Provisional application No. 63/607,455, filed on Dec. 7, 2023.

(51) Int. Cl. E06B 1/20

(52) U.S. Cl. CPC E06B 1/20

(57) ABSTRACT

A wall start for a modular wall. The wall start includes a base that affixes to an existing wall that may have irregularities and is not perfectly flat. The wall start also includes a connector coupled to the base. The connector and base can slide relative to one another to accommodate the irregularities in the existing wall. The base and connector are visually similar, providing an aesthetically pleasing coupling between the wall start and the wall. The connector can couple to a modular wall. A composite door including a glass panel and a panel frame. Levelers in the panel frame urge the panel frame and glass panel away from one another to load tension in the composite door, such that the glass panel and panel frame are mechanically united. The mechanical strength of the glass panel is joined with the strength of the panel frame to support the composite door.

### CROSS-REFERENCE TO RELATED APPLICATIONS

This application claims the benefit of priority to U.S. Provisional Application No. 63/607,455, filed on Dec. 7, 2023, the entire disclosure of which is incorporated herein by reference.

### BACKGROUND

### Background and Relevant Art

Modular walls provide flexibility in the design of a room. For example, modular walls can comprise a plurality of wall modules that can be built into an existing building or structure by fastening the modular walls to the existing walls.

As a practical reality, however, existing walls, doors, or doorframes in buildings are not always straight. The walls can be curved, slanted, offset, or otherwise out of plumb. Manufactured modular walls, however, are often produced to be straight and even. Any deviation from plumb, flat, or straight only is made more visible when a straight modular wall is placed against an uneven wall. In the past, there have been attempts to cover any gaps or inconsistencies between the existing walls and the modular walls with varying degrees of success.

Accordingly, there are a number of disadvantages in the art that can be addressed.

### BRIEF SUMMARY

The present disclosure is directed to a wall start, which includes a base comprising an elongated channel. The base is affixed to an existing wall in a building and is oriented vertically. The wall start also includes a connector comprising an elongated channel coupled to the base and oriented vertically. The connector can slidably move toward and away from the base to accommodate irregularities in the existing wall. A visible side of the base and a visible side of the connector are substantially visually similar. The base and connector can slidably adjust out of parallel with one another to accommodate the irregularities in the existing wall. The wall start also includes a modular wall coupled to the connector. The wall start can also include a leveler between the base and the connector. The leveler includes an extensible member coupled to the base and to the connector that is adjustable to move the connector toward and away from the base by extending the extensible member.

A wall start of the present disclosure can comprise a base comprising an elongated channel, the base being affixed to an existing wall in a building, the base being oriented vertically, a connector comprising an elongated channel coupled to the base and oriented vertically, wherein the connector can slidably move toward and away from the base to accommodate for irregularities in the existing wall, a visible side of, the base and a visible side of the connector are substantially visually similar and the base and connector can slidably adjust out of parallel relative to one another to accommodate the irregularities in the existing wall, and a modular wall being coupled to the connector.

A composite door of the present disclosure can comprise a glass panel, a panel frame surrounding the glass panel at a perimeter of the glass panel, and levelers in the panel frame, the levelers being configured to extend or urge the panel frame away from the glass panel such that the panel frame and glass panel are rigidly held against one another due to the levelers

A method of installing a modular wall against an existing wall of the present disclosure, the method comprising joining a base to the existing wall, the base being an elongated channel having a generally flat region that contacts the existing wall and is fastenable to the existing wall, the base further having protrusions extending away from the generally flat region, the base being vertically oriented coupling a connector to the base, the connector being an elongated channel having first components that are wider than the base and contact an outside of the protrusions of the base, and second components that are narrower than the base and contact an inside of the protrusions, wherein the first and second protrusions form an interference fit with the protrusions that permits the connector to slide relative to the base, wherein an outside of the first components and the protrusions are visually similar, wherein the connector further comprises keying features opposite the first and second components, joining a modular wall to the keying features of the connector, and sliding the connector relative to the base to account for irregularities in the existing wall.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific implementations thereof which are illustrated in the appended drawings. Understanding that these drawings depict only typical implementations of the invention and are not, therefore to be considered to be limiting of its scope, the invention will be described and explained with additional specificity and detail through the use of the accompanying drawings in which:

FIG. 1 is a depiction of a deviated existing wall interfacing with a traditional modular wall and a deviated wall interfacing with a wall start to accommodate the deviation according to embodiments of the present disclosure;

FIG. 2 illustrates a wall start being installed against a slanted existing wall 12 according to embodiments of the present disclosure;

FIG. 3 is a cross-sectional top view of a wall start according to embodiments of the present disclosure;

FIG. 4 is a cross-sectional top view of a telescoping wall start according to embodiments of the present disclosure;

FIG. 5 is an exploded view of the telescoping wall start according to embodiments of the present disclosure;

FIG. 6 is a cross-sectional top view of a progressive wall start according to embodiments of the present disclosure;

FIG. 7 illustrates an irregular door and a rectangular door according to the prior art;

FIG. 8 shows a composite door according to embodiments of the present disclosure;

FIG. 9 is a cross-sectional end view of a composite door, including levelers, according to the present disclosure;

FIG. 10 is a cross-sectional side view of a composite door according to embodiments of the present disclosure;

FIG. 11 is an exploded view of a leveler according to embodiments of the present disclosure;

FIG. 12A illustrates another embodiment of a composite door of the present disclosure featuring butt-hinges;

FIG. 12B illustrates a top half of the composite door of FIG. 12A;

FIG. 13A illustrates another embodiment of a composite door of the present disclosure featuring a sliding mechanism and double panes;

FIG. 13B illustrates a sliding mechanism of the composite door of FIG. 13A;

FIG. 13C illustrates a side view cross-section of the lower portion of the composite door of FIG. 13A; and

FIG. 13D illustrates a top-down cross-section of the composite door of FIG. 13A.

### DETAILED DESCRIPTION

The present disclosure is directed to modular walls and modular doors that are installed into existing structures. Often, existing structures can be uneven, and the walls and door frames can be slanted, crooked, and curved. Installing a straight or squared modular wall against an uneven existing wall makes the deviation from a perfectly flat wall much more noticeable. In such instances, gaps between the modular wall and the existing wall may also allow unwanted sound or temperature gradients to pass through the connection.

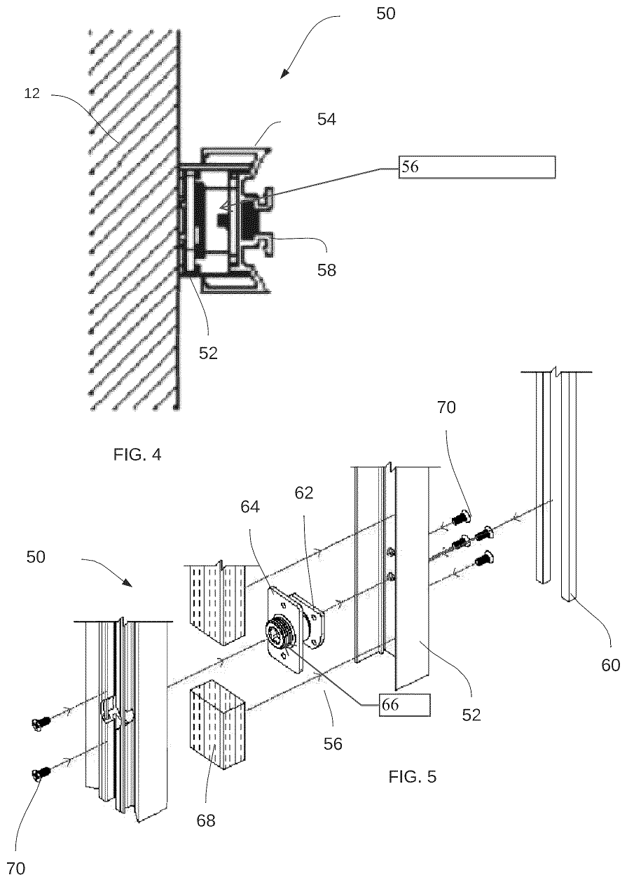

The present disclosure includes the use of a wall start that fastens to a deviated existing wall on one side and couples to a modular wall on the other side. The wall start can be an elongated extrusion made of a suitably strong material such as aluminum. The wall start can be made of at least two pieces: a base and a connector. The base is a generally U-shaped elongated channel fastened to the existing wall using an adhesive, screws, or other suitable connectors. In at least one implementation, the open side of the U-shaped channel faces away from the deviated existing wall, as shown in FIGS. 3, 4, and 6.

The connector is also an elongated, generally U-shaped channel facing the opposite direction, with the open sides of each U-shaped channel facing toward one another, as shown in FIGS. 3, 4, and 6. The U-shape nature of both the base and connector can also include engagement features that allow the base and connector to interface in a way that holds them together. For example, the U-shape of the connector can include a central portion and extending arms that themselves include two components each: a first component that fits outside the base and is wider than the base, and a second component that fits within the base and is narrower than the base. The connector can engage the base between the first and second components to hold the base and connector together while allowing them to slip relative to one another. FIG. 3 shows that the connector has first components wider than and positioned outside of the base and second components that are narrower than and positioned inside of the base. Therefore, the connector can be configured to be slightly wider than the base such that the U-shape of the base fits within the U-shape of the connector. The fit between the base and connector can be a slip fit or a friction fit. In either case, the fit permits the base and connector to slide relative to one another to thereby accommodate a flush fit to a deviated existing wall.

In other embodiments, the wall start includes a leveler fastened to the base and to the connector and is extensible to move the base and connector toward and away from one another. The levelers can also act as an anchor or supporting member for the attached modular wall. There may be multiple levelers at various places along the length of the wall start, and by adjusting the length of each, the wall start can accommodate the deviation in the wall. The base and connector slip relative to one another, and a visible edge of each can be similar in color and finish such that the seam between the base and connector is hardly visible, thereby improving the aesthetics of the modular wall considerably.

In some embodiments, the connector includes a connection to the modular wall. The connection can be a pinned connection, a friction fit connection, an adhesive connection, or any other suitable type of connection. In addition to modular walls, modular doors may also be accommodated. The connector can be coupled to a door frame, and the door frame carries the weight of a door. In other embodiments, the modular wall is a glass panel, and the connector can include a slot to receive the glass panel.

The wall starts can be filled with insulation to prevent unwanted sound from passing through the connection between the wall, base, the connector, and the modular wall fastened to the connector.

Throughout this disclosure, reference is made to modular walls and modular doors. Unless specifically noted herein, modular walls and modular doors or panels and doors can be interchangeable.

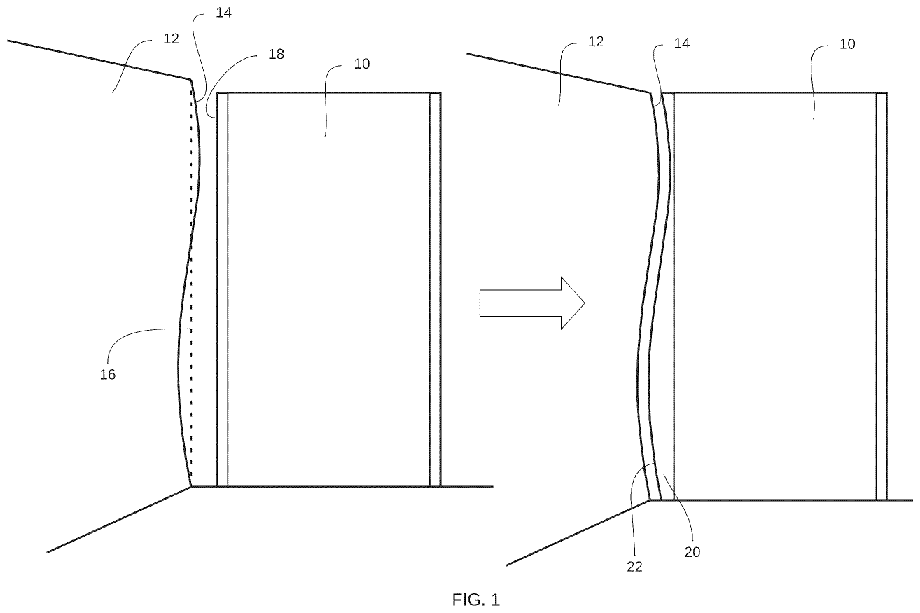

FIG. 1 depicts a deviated existing wall 12 interfacing with a traditional modular wall wherein the deviated existing wall 12 also interfaces with a wall start of the present disclosure to accommodate for the deviation of the deviated existing wall 12. FIG. 1 further shows by way of exemplary illustration that the deviated existing wall 12 has an exaggerated curved shape, showing its deviation from a theoretical flat plane 16. As understood more fully herein, the present disclosure accommodates a modular wall 10 to be installed against the deviated existing wall 12, wherein there is no gap between the two walls. The deviated existing wall 12 has a contact surface 14 that is convex in places and concave in others. The contact surface may also be slanted or otherwise deviate from a theoretical flat plane 16. The modular wall has an edge 18 that is flat and will not fit flush against the existing deviated wall 12.

Implementing the present disclosure can yield at least the following result. For example, a manufacturer or assembler may place a wall start 20 between the deviated existing wall 12 and the modular wall 10. The inventive wall start 20 may be configured to enable shape adjustment, thereby allowing its shape to form an exposed edge 22 that has a similar shape to the contact surface 14 of the deviated existing wall 12. In at least one embodiment, wall start 20 is configured with a bespoke fit or shape for plump fitting when installed. The manufacturer or assembler can then connect the modular wall 10 to the wall start 20, resulting in a flush fit.

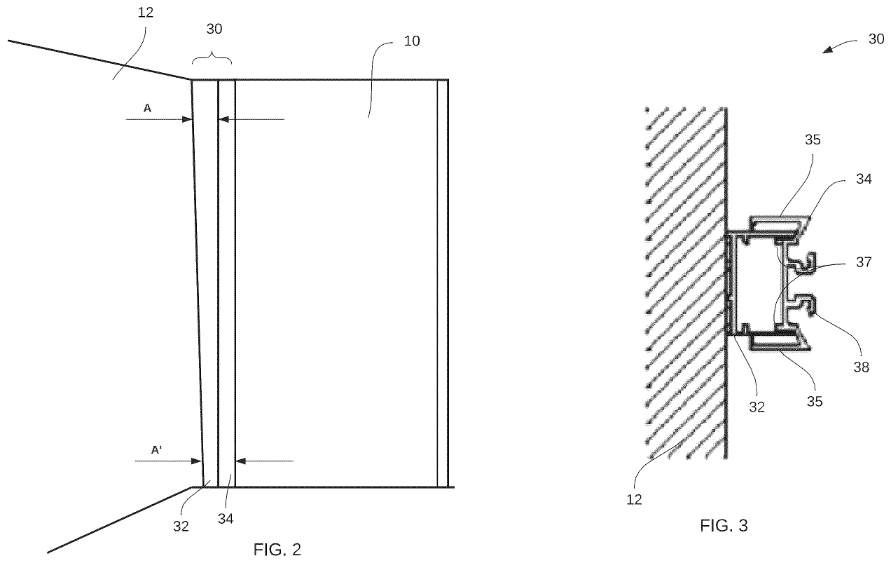

FIG. 2 illustrates a wall start 30 being installed against a slanted deviated existing wall 12 according to embodiments of the present disclosure. FIG. 2 further illustrates that, while the modular wall 10 is flat or squared along its edge, the deviated existing wall 12 is slanted away from the modular wall 10 at the top (unlike in FIG. 1, where the deviated wall's deviation is curved in nature). The wall start 30 can include a base 32 that is fastened to the deviated existing wall 12 with an adhesive, screws, another suitable fastener, or any combination thereof. Base 32 is a U-shaped channel wherein the bottom or vertex of the U is secured to the deviated existing wall 12. FIG. 2 also shows that the wall start 30 includes a connector 34 that is coupled to the base in an adjustable manner. One will appreciate that the exposed surfaces of the base 32 and connector 34 can be similar in terms of color and finish such that the seam between the base 32 and the connector 34 is minimally visible. This visual cohesiveness allows users of a wall start of the present inventions to seamlessly integrate modular walls or doors into their preexisting space without gaps, thermal or sound transfers between spaces, or unsightly or out-of-place joinders or adapters.

FIG. 2 further shows that the distance A at the top of deviated existing wall 12 relative to modular wall 10 is larger than the distance A′ at the bottom; however, due to the adjustability and slipping fit between the base 32 and connector 34, and because of the similar appearance of the base 32 and connector 34, the deviation can be mitigated and in many cases is essentially visibly imperceptible, or difficult to detect. The sound insulation properties of the modular wall 10, when installed against the deviated existing wall 12, can be improved. To this end, open spaces within the wall start 30 can be filled with an insulating material such as denim insulation.

FIG. 3 is a cross-sectional top view of the wall start 30 according to embodiments of the present disclosure. Wall start 30 is fastened against a deviated existing wall 12. Wall start 30 includes a base 32 that is an elongated U-shaped channel with a middle section or vertex of the U that is fastened to the deviated existing wall 12 and with the open side of the U facing outward from the deviated existing wall 12. The wall start 30 can also include a connector 34, which is also a substantially elongated U-shaped channel. The connector 34 is open toward base 32 and is wider than the base 32, such that the U-shaped channel of the connector 34 envelopes the base 32. In some embodiments, the base 32 can be wider than the connector 34, or in other embodiments, the U-shaped channels of the base 32 and connector 34 can be the same size and can be offset such that one end of the U of the base 32 is inside the U of the connector 34, and one side of the U of the connector 34 is inside the U of the base 32.

The fit between the base 32 and connector 34 may be a friction fit or a slip fit that allows the sliding of the connector 34 relative to the base 32 toward and away from the deviated existing wall 12. In many cases, the deviation from the flat of the existing walls is slight; however, to accommodate a larger deviation, the size of the wall starting 30 can be adjusted to accommodate. The length of the sides of the U-shaped channels of the base 32 and connector 34 can be larger or smaller to accommodate deviations of varying sizes.

In some embodiments, as shown in FIG. 3, the connector 34 includes first components 35 that are wider than and contact an outside surface of the base 32, and second components 37 that are narrower than and contact an inner surface of the base 32. The first components 35 and the second components 37 form an interference fit with the base 32. The connector 34 can slide toward and away from the base 32, but the interference fit between the base 32 and the first components 35 and second components 37 provides some resistance to the slippage and helps maintain the position between the base 32 and connector 34. In some embodiments, an adhesive can be placed between the base 32 and connector 34 to hold them in place once the assembler is satisfied with the relative position of the base 32 and the connector 34. As described above, insulation can also be placed between the base 32 and connector 34 to decrease the audio and thermal transfer through the wall start 30.

The connector 34 can be coupled to a modular wall, allowing the wall start 30 to provide support, stability, and sound insulation to the modular wall. The connector 34 can include keyed features 38 that mate with the modular wall and secure the connector 34 to the modular wall. A pin or key (not shown) can selectively engage the keyed features 38 and corresponding keyed features (not shown) on a modular wall.

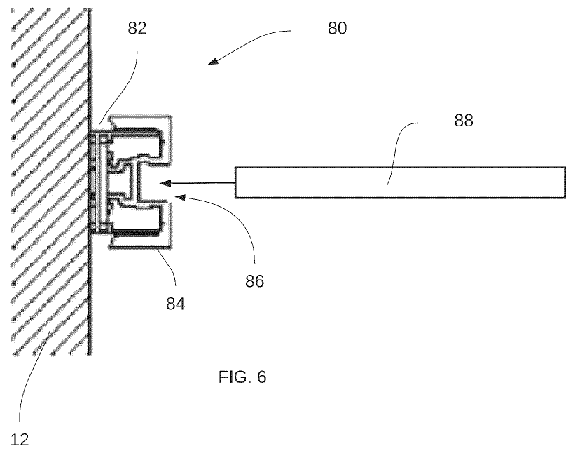

FIG. 4 is a cross-sectional top view of a telescoping wall start 50 according to embodiments of the present disclosure. Similar to wall start 30, telescoping wall start 50 is positioned against a deviated existing wall 12 and is fastened or secured to the deviated existing wall 12 with an adhesive or screws. The telescoping wall start 50 includes a base 52, a U-shaped elongated channel that is oriented upright and can extend from the floor to the ceiling or, in some cases, as high as the modular wall, which it will support, extends. The telescoping wall start 50 includes a connector 54 that couples with the base 52 in a similar manner as wall start 30, shown in FIG. 3. Connector 54 can slidably move toward and away from the deviated existing wall 12 to accommodate for any irregular features of the wall. The visible sides of the base 52 and connector 54 can be visually the same or similar enough that regardless of the position of the connector 54 relative to the base 52, the seam is less noticeable.

The telescoping wall start 50 includes a leveler 56 that is coupled to the base 52 and to the connector 54 and includes an extensible member 66 within that, when extended, urges the connector 54 away from the base 52 and, when retracted, urges the connector 54 toward the base 52. The connector 54 can include an access hole through which the extensible member can be reached and manipulated to extent or retract the leveler 56. In some embodiments, the extensible member 66 is a threaded member that, when turned, extends or retracts the connector 54 from the base 52. The extension and retraction capabilities of the extensible member 66 can be the telescoping aspect of the telescoping wall start 50. Leveler 56 can also provide structural support for the wall start 50 as well as any modular wall, door, or frame that is connected through keyed features 58. For example, the extensible member 66 provides connector 54 with a connection to the deviated existing wall 12 by way of base 52. Connector 54 is then a solid or firm anchor point for any modular wall, door, or frame connected by keyed features 58.

The telescoping wall start 50 can include multiple levelers 56 at various vertical positions along the base 52 and connector 54. The base 52 and connector 54 can be somewhat flexible and the adjustment of the leveler 56 can cause the connector 54 or base 52 to deflect slightly to accommodate for irregularities in the wall. In some cases where a wall is curved, for example, a first leveler can be used to extend the connector 54 further out or away from base 52, and in another place, a second leveler can be used to retract the connector 54 towards base 52.

The connector 54 can include keying features 58 that engage with a wall to which the telescoping wall start 50 will attach. The keying feature 58 can accommodate access to the extensible member in the leveler 56.

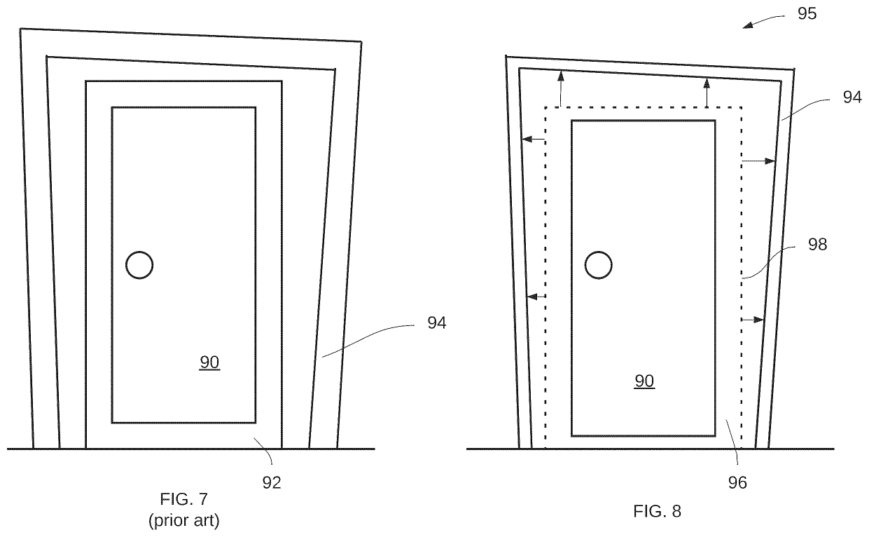

FIG. 5 is an exploded view of the telescoping wall start 50 according to embodiments of the present disclosure. The wall (not pictured) would be on the right-hand side of FIG. 5. The deviated existing wall, in some cases, includes posts 60 that may be used by the telescoping wall start 50. Posts 60 can be embedded within the existing deviated wall or attached to an outer surface of the existing deviated wall. Telescoping wall start 50 includes a base 52 that is an elongated U-shaped channel with the open side of the U facing away from the wall. The leveler 56 is shown with a first plate 62 fastened to the base 52, a second plate 64 fastened to the connector 54, and an extensible member 66 held between the first plate 62 and the second plate 64. The extensible member 66 can be a threaded member such as a bolt or screw that can be rotated with a screwdriver, a socket tool, or another type of tool.

Screws 70 can be used to hold the telescoping member to the first plate 62 and the second plate 64. In some embodiments, a plurality of levelers 56 can be located along the length of base 52 and connector 54. An installer or end user will appreciate the adjustability and stability that levelers 56 provide; for example, if telescoping wall start 50 consists of two levelers 56, wherein each leveler 56 is located at opposing ends of the length of telescoping wall start 50, the installer or end user can manipulate both extensible members 66 to alter the orientation of base 52 in relation to connector 54. Insulation 68 can then be placed in open spaces within the telescoping wall start 50 to deaden sound.

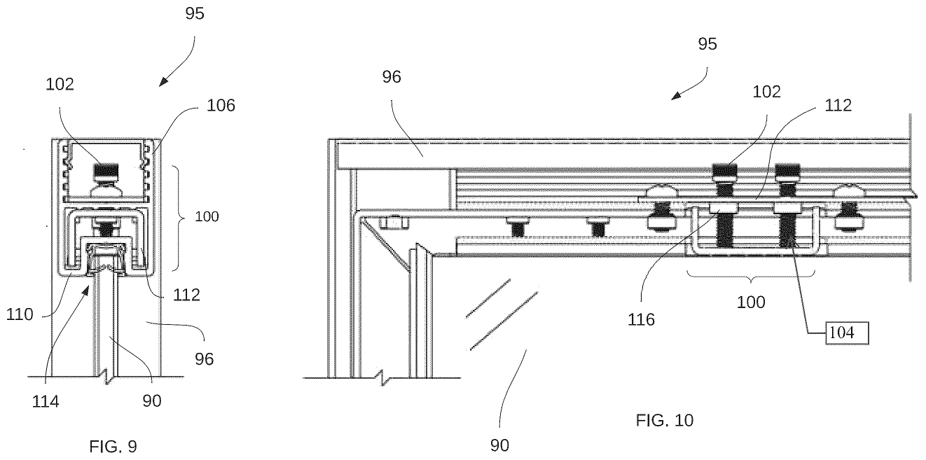

FIG. 6 is a cross-sectional top view of a progressive wall start 80 according to embodiments of the present disclosure. The progressive wall start 80 is fastened to a deviated wall 12 that may have irregularities or deviations from flat. The progressive wall start 80 includes a base 82 and a connector 84 that interface and function similarly to other wall starts shown and described herein, such as wall starts 20, 30, and 50. The connector 80 can include a slot 86 to receive a glass panel 88. The glass panel 88 is at least a portion of the modular wall component that is supported by the progressive wall start 80. The slot 86 can be large enough to accommodate a glass panel 88 with a friction fit, with an adhesive, or another type of fastener configured to secure the glass panel 88 into slot 86. Slot 86 can comprise or further be sized to accommodate a seal that is configured to restrict the transfer of heat and sound, as well as secure glass panel 88 into slot 86. Progressive wall start 80 can include any of the disclosure features of the previously discussed wall starts. For example, in at least one embodiment, a leveler or plurality of levelers can be present within progressive wall start 80 to enable how a glass panel is oriented and provide a structural base that can support the glass panel.

In at least one embodiment, a plurality of slots 86 can be present on connector 84. In such an example, two slots 86 can be present such that two glass panels 88 are supported by progressive wall start 80. A small air gap can be present between the two glass panels 88 and is defined by the spacing between the two slots 86.

The wall starts of the present disclosure allow for the installation of modular walls into existing buildings whose walls may have irregularities, deformations, warping, slanting, and other departures from theoretical perfect straight lines. Irregularities are common in structures and are not generally noticeable; however, installing a new modular wall or door into an existing building that has irregularities makes those irregularities much more noticeable. The base and connector structure of the wall starts of the present disclosure allow these irregularities to be hidden due to the adjustability and flexibility of the wall starts that is achieved by moving the base and connector relative to one another to accommodate the irregularities. In the case of the leveler-equipped wall start, a sinuous shape can be achieved to match a sinuous, curved wall without needing an unsightly and possibly expensive cover, cap, trim, or paint.

The present disclosure is also directed to a glass door or composite door leveling mechanism. There is a growing demand for doors with thicker acoustic-resistant glass panels and slimmer, less intrusive frames. As the frames and support structures become thinner and glass thickness increases, support structures made out of aluminum or other strong materials often can be not strong enough to support thicker and more sound or temperature-resistant glass panels. To accommodate this, the glass door leveling mechanism of the present disclosure secures a frame member to the glass panel in a secure and strong manner such that the strength of the glass panel itself acts as a support member for the glass panel and the surrounding frame structure. In at least one embodiment, the panel frame and glass panel can have approximately the same thickness

The glass door leveling mechanism includes a glass panel and a metal frame around the perimeter of the glass panel. Within the frame, levelers can be positioned to expand against the perimeter of the glass panel and against a portion of the frame. The levelers establish a tension within the glass panel and frame combination, thereby strengthening the overall assembly. With sufficient tension in the levelers, the glass panel and frame can be mechanically equivalent to a single sheet of material, and therefore, a thinner frame and a thinner glass panel together can be strong and robust.

The levelers also allow for some adjustments to the size and shape of the frame around the glass panel. The glass panels of the present disclosure can be doors or walls, and in each case, they can be installed into an existing building, which may have irregularities. The levelers can adjust the shape of the glass panel and frame unit to fit within the space provided such that the irregularities in the wall or door frame do not result in a poor fit with the glass panel. As previously mentioned, when similar glass panels become thicker to provide acoustic or thermal resistance, slimmer frames can begin to bow or deform under the weight of the panels. The present disclosure solved this by making the glass or similar panel a structure member of the composite door. This then provides that the composite door no longer bows or deforms and remains plumb or squared.

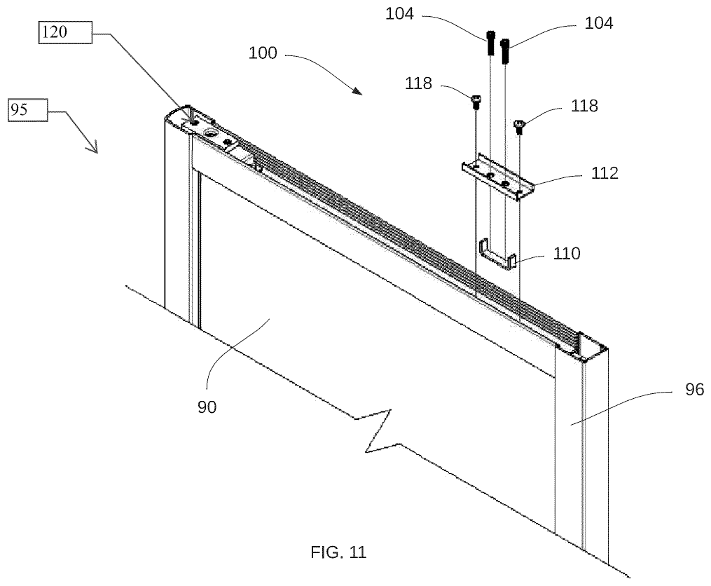

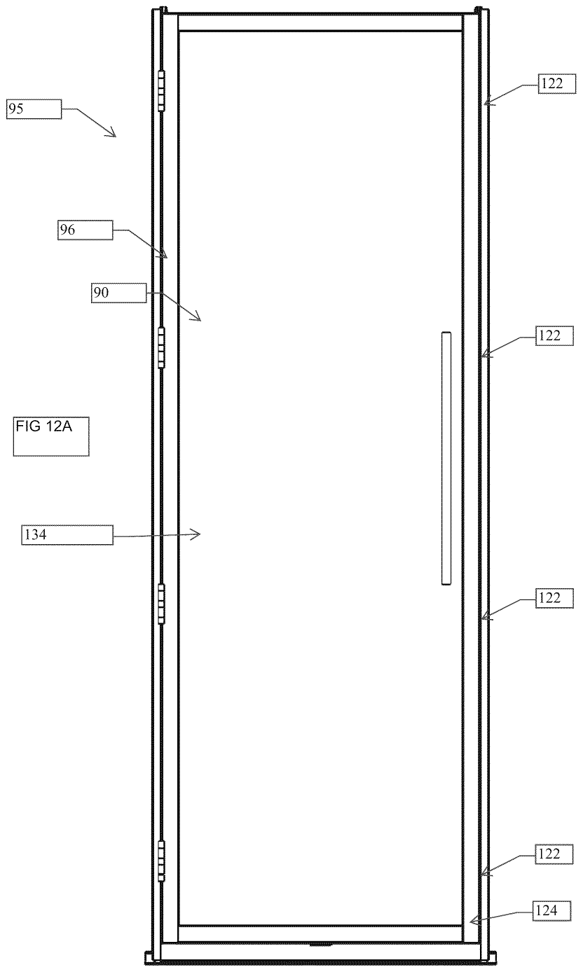

FIGS. 7 and 8 show comparisons of a prior art door without use of the present disclosure with a door mounted in accordance with the present disclosure. For example, FIG. 7 illustrates an irregular door frame 94 and a door panel 90. The door includes a door panel 90 and a panel frame 92. The door frame 94 may have irregularities or may not be strong enough to support the weight of door panel 90, which makes fitting the door panel 90 within the door frame 94 difficult. The door frame 94 is irregular and the irregularities are exaggerated for purposes of explanation. Accommodating the irregularities is difficult without the present disclosure, and the result is a poor fit that may not be able to close, and that performs poorly in terms of sound and thermal insulation.

FIG. 8 shows a composite door 95 according to embodiments of the present disclosure. The composite door 95 includes a door panel 90 and a panel frame 96 that is secured to the door panel 90 around the perimeter of the door panel 90. The Door frame 94 is irregular; however, the adjustments provided by the present disclosure's levelers can adjust for the irregularities and allow the composite door 95 to fit within door frame 94. In the depicted embodiment, the arrows show how the panel frame 96 can expand selectively or be manipulated by levelers to fit within the door frame 94.

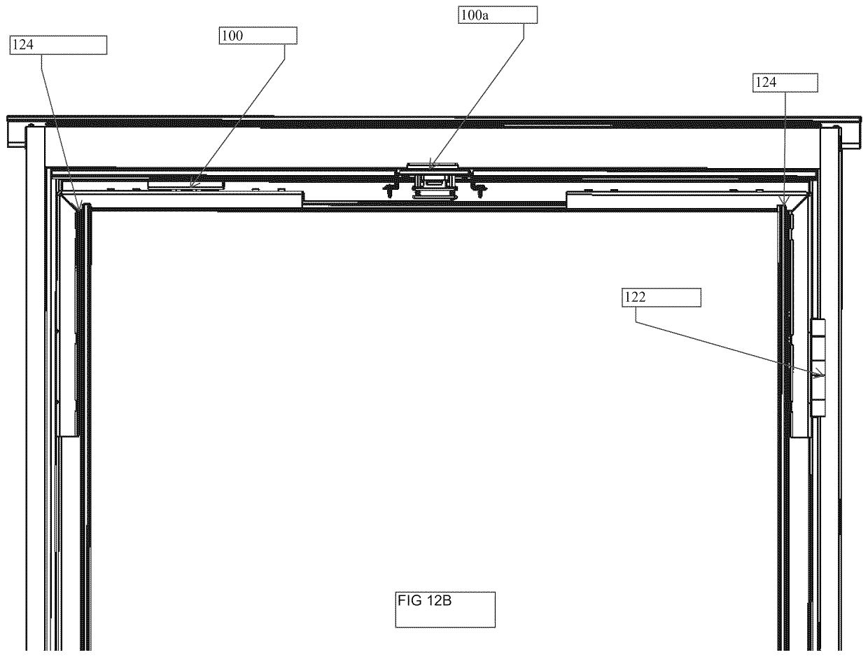

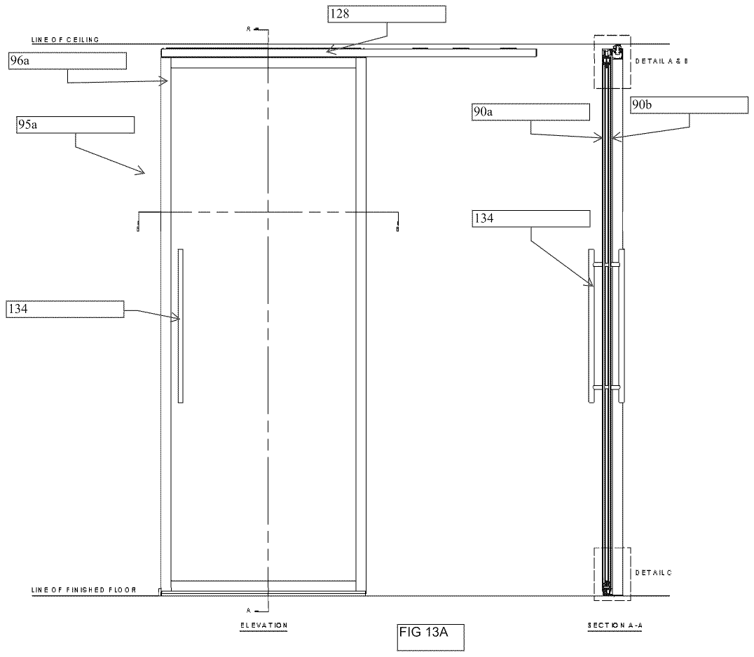

FIG. 9 is a cross-sectional end view of a composite door 95, including levelers, according to the present disclosure. FIG. 10 is a cross-sectional side view of the composite door 95 according to the embodiments of the present disclosure. Reference is now made to both FIGS. 9 and 10 using like reference numerals for each.

FIGS. 9 and 10 show that composite door 95 includes one or more levelers 100 within panel frame 96. FIGS. 9 and 10 further show that the leveler(s) 100 can include a knob 102 and a bolt 104. Turning the knob 102 and bolt 104 extends and retracts the bolt 104. Extending bolt 104 causes the leveler 100 to urge the panel frame 96 away from the door panel 90, thereby creating tension that unites the door panel 90 and panel frame 96 in terms of mechanical stability and thus allowing the panel to assist in carrying the weight of the composite door. The leveler 100 includes a first component 110 that is between or connected to the bolt 104 and the door panel 90. The first component 110 can also include a slot 114 that receives the door panel 90. The leveler 100 also includes a second component 112 that is between or connected to the panel frame 96 and the bolt 104. A stop 116 allows the leveler 100 to provide the desired force to create tension in panel frame 96. The knob 102 can be rotated manually or with a tool such as a screwdriver or similar tool.

In another embodiment of a leveler of the present disclosure, the bolt can pass through and engage with threads disposed on the first and second components. The threads on the first component can be inverted from the threads on the second component such that when the bolt is engaged with both the first component and the second component, the rotation of the bolt expands or contracts the distance between the first component relative to the second component. As described previously, since the first component is in contact with or connected to the door panel and the second is in contact with or connected to the frame, an expansion would increase the distance between the frame and the door, and a contraction would decrease the distance between the frame and the door. This single rotation solution provides an installer of a composite door of the present disclosure a simple, fast, and effective means of securing the door panel to the frame as well as correcting for any drooping, sagging, or deformation in the frame.

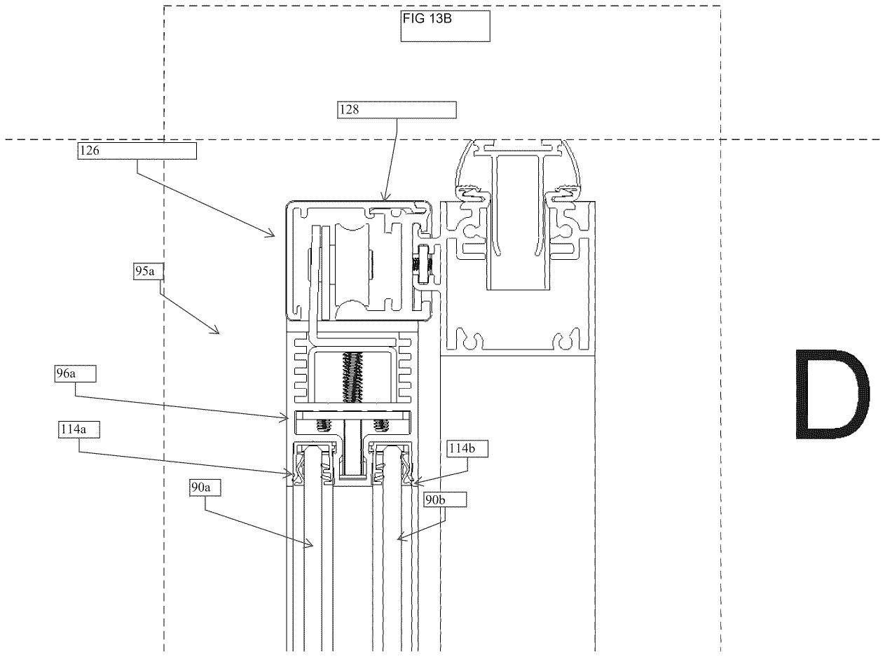

FIG. 11 is an exploded view of the leveler 100 according to the embodiments of the present disclosure. The leveler 100 includes bolts 104, first component 110, and second component 112. Screws 118 secure the second component 112 to the panel frame 96. Rotating the bolts, 104 causes the first component 110 to move towards or away from the second component 112, thereby adjusting the panel frame 96 as needed and urges the panel frame 96 into tension with the door panel 90. With proper tension, panel frame 96 and door panel 90 can be mechanically united, and the strength and rigidity of the door panel 90 is used to supplement for the weaker or thinner panel frame 96 members.

There may be many levelers around the panel frame 96 or any composite door of the present disclosure to allow for a greater degree of adjustability due to their placement around the panel frame 96. In some embodiments, there is at least one leveler 100 on each side of the panel frame 96. For a rectangular or square panel, there can be four levelers. In other embodiments, there is a leveler at certain intervals, such as one per two feet of the panel frame 96. The inherent flexibility of the panel frame 96 allows for the adjustment to accommodate the irregularities in the wall or door frame into which the composite door 95 will be installed.

FIG. 11 additionally illustrates swinging mechanism 120. Swinging mechanism 120 is configured to allow the composite door 95 to be secured to a corresponding pin or similar mechanism embedded into a floor, ceiling, or modular wall or doorframe that enables the swinging operation of the composite door 95.

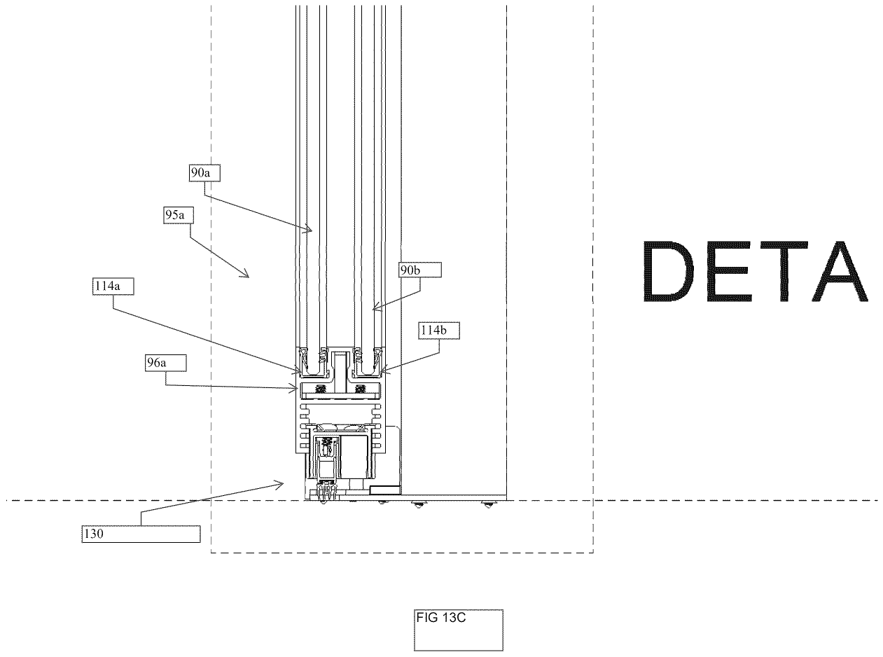

In another embodiment, as shown in FIGS. 12A-12B, composite door 95 has butt-hinges or hinges 122 affixed on at least one of its edges to allow for the opening and closing of the composite door. Panel frame 96 is secured to the perimeters of door panel 90 and can include a plurality of levelers. Panel frame 96 is also secured to a plurality of hinges 122 that assists in carrying the load of composite door 95. Additionally, operating mechanism 134, illustrated as a handle, is secured to door panel 90. Operating mechanism 134 can also be a traditional lever or handled doorknob mechanism. In such an embodiment, the operating mechanism can include a latching and/or locking mechanism configured to secure composite door 95 in a closed position selectively.

FIG. 12B is the top half of the composite door 95 shown in FIG. 12A. As illustrated, panel frame 96 is transparent, which allows corner supports 124 to be visible. In some embodiments, corner support 124 are structural members that interface with door panel 90. Corner supports 124 can be substantially flat metal members bent along their length to form a 90-degree member. In another embodiment, corner supports 124 are more substantial metal structures and include a channel or slot, similar to slots of the present disclosure, that can receive door panel 90. A cushioning material or seal can be placed between the corner supports 124 and the door panel 90 to prevent damage. Corner supports 124 may also interface with additional structural or support members, such as panel frame 96. This interfacing can be done through indexing or mechanical communication through fasteners. In another embodiment, corner supports 124 can directly interface with one or more levelers, such as leveler 100 or 100a, of the present disclosure before interfacing with a panel frame 96. Corner support 124 can also be configured to reinforce the corners of door panel 90 in cases where door panel 90 is made of glass or otherwise breakable material. As shown in FIG. 12, corner support 124 can also interface with hinges 122 and assist in carrying the load of composite door 95.

A plurality of levelers 100 or 100a can be selectively secured around the perimeter of the composite door 95. Levelers 100 or 100a can be configured to push door panel 90 away from panel frame 96 or to pull door panel 90 towards panel frame 96.

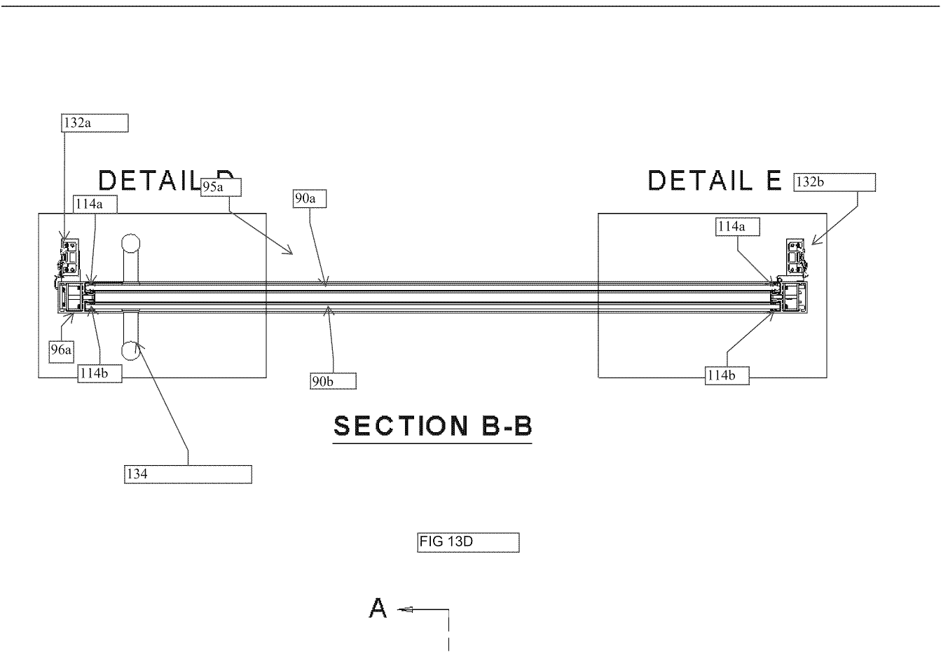

FIG. 13A-13D illustrates another embodiment of a composite door of the present disclosure featuring a sliding mechanism 126 and double panes. Composite door 95, rather than having hinges 122, has a sliding mechanism 126 affixed along one of its upper edges. FIGS. 13A and 13B illustrate a front and side cross-sectional perspective of composite door 95a. Composite door 95a can have substantially the same elements and components as any composite door 95 of the present disclosure in at least one embodiment. Composite door 95a is illustrated as comprising operating mechanism 134, or a handle that allows a user to open or close the door. Composite door 95a is configured to slidably operate along the length of track system 128.

FIG. 13B illustrates how sliding mechanism 126 is configured to interface with a corresponding track system 128, which is coupled to a modular door frame, wall, or structure. Composite door 95a can be configured to slide into a pocket or along a wall's front or rear face during the opening and closing of composite door 95a.

Composite door 95a further comprises door panels 90a and 90b. Door panels 90a and 90b are similarly secured to a panel frame 96a as in previous embodiments. This means door panels 90a and 90b can interface with corner supports, slots, levelers, and panel frame members. Slots 114a and 114b are configured to receive either door panels 90a or 90b. Slots 114a and 114b are configured to secure door panels 90a and 90b such that an air gap is present between the panels. In another embodiment, door panels 90a and 90b are secured so there is no gap between them. For example, the two door panels can be secured within a single slot. The double pane nature of composite door 95 allows thinner door panels to be used while providing the same or better thermal and sound resistances. This can save money and manufacturing time as thicker panels do not need manufacturing.

FIG. 13C illustrates a side view cross-section of the lower portion of composite door 95a. Along with the elements previously mentioned, composite door 95a comprised lower member 130. In one embodiment, lower member 130 is a flexible/nonflexible runner, brush, aesthetic cover, or sealing member configured to fill the gap between a floor and the composite door 95a. In another embodiment, lower member 130 comprises a sliding track. In such an embodiment, the sliding track can be configured to secure or interact with a floor below the composite door and aid in sliding the composite door 95a. Regardless of embodiment, lower member 130 is configured to couple to panel frame 96a selectively.

FIG. 13D illustrates a top-down cross-section of composite door 95a. Along with the elements previously mentioned, composite door 95a comprises stoppers 132a and 132b. Stoppers 132a and 132b can be configured to secure composite door 95a in a fully open or closed state. Stoppers 132a and 132b are structural frame members of a modular wall or door. Further, operating mechanism 134 is shown interacting with door panels 90a and 90b. Operating mechanism 134 is adhered or mechanically secured to door panels 90a and 90b. In at least one embodiment, operating mechanism 134 is configured to pass through holes in door panels 90a and 90b to secure the handles on either side of the composite door together or to interact with a locking mechanism placed between the two door panels.

The composite doors shown and described herein in FIGS. 8-13D are better equipped to handle the mechanical loads and constraints associated with glass panel doors and walls. There is increasing demand for thicker glass panels; however, if the frames surrounding the glass panels also become thin, there may be insufficient strength provided by the frames alone to support the entire structure. Furthermore, fitting into an irregular door frame (or, in the case of a modular wall, the site of the modular wall) is difficult. In comparison to wood or metal or other materials, glass is more difficult to trim, flex, and fit into an irregular space. Thicker glass panels that help with increasing a wall or door sound and thermal resistance are able to be used while also allowing the doors and walls of the present disclosure to be slimmer and more aesthetically pleasing without drooping, warping, or deforming under the increased load.

These and other problems are addressed by the present invention. The panel frame for the door or wall panel exerts a compressive force to mechanically unite the door panel, and the panel frame allows for the weight of the door or wall to be transferred through the glass panel itself; thus, it is not carried primarily by the panel frame. Also, if there is an irregularity in the door frame (or site for the modular wall), adjusting the levelers that are positioned throughout the panel frame allows for the glass panel and panel frame to be adjusted slightly without requiring an on-site cutting of the glass panel, which may be prohibitively expensive, labor intensive, and equipment intensive. Irregularities in buildings are more common than commonly known, and such irregularities do not generally pose a problem. However, when a new and substantially squared modular door or wall that does not have irregularities is placed in communication with a wall or structure that does, the irregularities become much more noticeable. The composite doors of the present disclosure can be implemented in conjunction with the modular wall at the start of the present disclosure.

The present invention may be embodied in other specific forms without departing from its spirit or essential characteristics. Aspects of the present disclosure described and shown with respect to a door can apply equally to walls and wall panels. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A wall start comprising:
a base comprising an elongated channel, the base being affixed to an existing wall in a building, the base being oriented vertically;
a connector comprising an elongated channel coupled to the base and oriented vertically,
wherein:
the connector can slidably move toward and away from the base to accommodate for irregularities in the existing wall,
a visible side of the base and a visible side of the connector are substantially visually similar, and
the base and connector can slidably adjust out of parallel relative to one another to accommodate the irregularities in the existing wall; and
a modular wall being coupled to the connector.

2. The wall start of claim 1, further comprising a leveler between the base and the connector, the leveler comprising:
an extensible member coupled to the base and to the connector, the extensible member being adjustable to move the connector toward and away from the base by extending the extensible member.

3. The wall start of claim 2, the leveler further comprising a first plate coupled to the base and to the extensible member and a second plate coupled to the connector and the extensible member wherein the first plate and second plate provide structural support for the modular wall.

4. The wall start of claim 2 wherein the extensible member comprises a threaded bolt.

5. The wall start of claim 2, further comprising a plurality of levelers spaced at different vertical positions along the wall start, wherein individual levelers can be extended and retracted independently to accommodate irregularities in the existing wall at the different vertical positions.

6. The wall start of claim 1, the connector including a slot configured to receive a glass panel.

7. The wall start of claim 1 wherein the base comprises a U-shaped channel having an open side oriented away from the existing wall, wherein the connector comprises a U-shaped panel having an open side facing toward the base, wherein the open side of the base and the open side of the connector interface together in a friction fit that allows slidable movement between the base and connector.

8. The wall start of claim 1 further comprises a denim insulation configured to be selectively inserted into a space between the base and the connector.

9. The wall start of claim 1 wherein the connector further comprises keying features configured to allow for selective coupling to a modular frame.

10. The wall start of claim 7 wherein the connector comprises first components that are wider than the base and contact an outside surface of the base, and second components that are narrower than the base and contact an inside surface of the base.

11. A composite door, comprising:
a glass panel;
a panel frame surrounding the glass panel at a perimeter of the glass panel; and
levelers in the panel frame, the levelers being configured to extend or urge the panel frame away from the glass panel such that the panel frame and glass panel are rigidly held against one another due to the levelers.

12. The composite door of claim 11 wherein the levelers are individually adjustable to shape the panel frame to fit a door frame that has irregularities.

13. The composite door of claim 11 wherein the panel frame is joined together at corners of the panel frame such that the levelers urging the panel frame away from the glass panel causes the composite door to be mechanically united.

14. The composite door of claim 11 wherein the glass panel and panel frame are held in tension together such that forces on the composite door that act on the panel frame are conveyed through the glass panel due to the levelers.

15. The composite door of claim 13 further comprises a plurality of corner supports configured to structurally support the composite door and reinforce the glass panel.

16. The composite door of claim 11 wherein the levelers comprise:
a bolt;
a first component fastened to the panel frame;
a second component fastened to the glass panel, wherein the bolt is threadably coupled to the first component and the second component such that rotating the bolt causes the first component to move toward and away from the second component.

17. A method of installing a modular wall against an existing wall, the method comprising:
joining a base to the existing wall, the base being an elongated channel having a generally flat region that contacts the existing wall and is fastenable to the existing wall, the base further having protrusions extending away from the generally flat region, the base being vertically oriented;
coupling a connector to the base, the connector being an elongated channel having first components that are wider than the base and contact an outside of the protrusions of the base, and second components that are narrower than the base and contact an inside of the protrusions,
wherein the first and second protrusions form an interference fit with the protrusions that permits the connector to slide relative to the base,
wherein an outside of the first components and the protrusions are visually similar,
wherein the connector further comprises keying features opposite the first and second components;
joining a modular wall to the keying features of the connector; and
sliding the connector relative to the base to account for irregularities in the existing wall.

18. The method of claim 17 wherein the base further comprises a leveler coupled to the base and to the connector, the leveler comprising an extensible member configured to extend to move the connector away from the base, and to retract to move the connector toward the base, the method further comprising adjusting a relative position of the connector relative to the base using the leveler.

19. The method of claim 18 wherein the leveler comprises a plurality of levelers at two or more different vertical positions between the base and the connector, the levelers being independently extensible to adjust a relative position of the connector and the base to accommodate irregularities in the existing wall.

20. The method of claim 17 wherein at least one of the base and connector is sufficiently flexible to permit the base to accommodate irregularities in the existing wall, and for the connector to accommodate the modular wall.
